(19) United States
(12) Patent Application Publication
(10) Pub. No.: US 2021/0207674 A1
(43) Pub. Date: Jul. 8, 2021

(54) FRICTION MATERIAL

(71) Applicant: BorgWarner Inc., Auburn Hills, MI (US)

(72) Inventors: Richard W. PRIDGEN, JR., Arlington Heights, IL (US); Feng DONG, Rochester, MI (US); Deanna L. MILLER HIGGINS, Berkley, MI (US); Benjamin A. SIEGEL, Chicago, IL (US); David T. VIERK, Mokena, IL (US)

(21) Appl. No.: 17/139,439

(22) Filed: Dec. 31, 2020

Related U.S. Application Data
(60) Provisional application No. 62/958,023, filed on Jan. 7, 2020.

(51) Int. Cl. F16D 69/02; F16D 13/72; F16D 13/74

(52) U.S. Cl. CPC F16D 69/026; F16D 13/72; F16D 2200/0069; F16D 2200/0078; F16D 2200/0056; F16D 13/74

(57) ABSTRACT

A friction material includes a friction-generating layer, a core layer, and a base layer. The friction-generating layer presents a friction-generating surface and includes a friction-generating material. The friction-generating material includes friction-adjusting particles. The core layer is adjacent to the friction-generating layer and includes a core material. The core material includes core fibers. The base layer is adjacent to the core layer such that the core layer is disposed between the friction-generating and base layers. The base layer presents a bonding surface facing opposite the friction-generating surface of the friction-generating layer. The base layer includes a fibrous material. The fibrous material includes base fibers chosen from aramid fibers, carbon fibers, cellulose fibers, acrylic fibers, polyvinyl alcohol fibers, glass fibers, mineral fibers, and combinations thereof. A resin is present in at least one of the friction-generating layer, the core layer, and the base layer.

### CROSS-REFERENCE TO RELATED APPLICATION

The subject patent application claims priority to and all of the benefits of U.S. Provisional Patent Application No. 62/958,023, filed on Jan. 7, 2020, the disclosure of which is hereby incorporated by reference.

### FIELD OF THE DISCLOSURE

This disclosure generally relates to a friction material that includes three layers and that may be used in a variety of different applications including in a friction plate in a clutch assembly in a transmission.

### BACKGROUND

Several components of a powertrain of a motor vehicle may employ a wet clutch to facilitate the transfer of power from the vehicle's power generator (e.g. an internal combustion engine, electric motor, fuel cell, etc.) to drive wheels of the motor vehicle. A transmission located downstream from the power generator that enables vehicle launch, gear shifting, and other torque transfer events is one such component. Some form of a wet clutch is commonly found throughout many different types of transmissions currently available for motor vehicle operation.

A wet clutch is an assembly that interlocks two or more opposed, rotating surfaces in the presence of a lubricant by imposing selective interfacial frictional engagement between those surfaces. At the point of engagement, a friction material is utilized to generate the interfacial frictional engagement. The friction material is supported by a friction clutch plate, a band, a synchronizer ring, or some other part. The presence of the lubricant at the friction interface cools and reduces wear of the friction material and permits some initial slip to occur so that torque transfer proceeds gradually, although very quickly, in an effort to avoid the discomfort that may accompany an abrupt torque transfer event (i.e., shift shock).

Friction materials used in the variety of wet clutches found in motor vehicle powertrains must be able to withstand repeated forces and elevated temperatures that are typically generated during the repeated engagement and disengagement of transmissions. During use, the friction material must be able to maintain a relatively constant friction throughout engagement, i.e., frictional engagement on one or more of its surfaces, maintain cohesive integrity, and, where applicable, maintain adhesion to the substrate for thousands of engagements and disengagements of such transmissions.

In view of the above, there remains an opportunity to develop a friction material with improved performance properties in a wide variety of different wet clutch applications.

### SUMMARY OF THE DISCLOSURE

A friction material including a friction-generating layer, a core layer, and a base layer is disclosed. The friction-generating layer presents a friction-generating surface and includes a friction-generating material. The friction-generating material includes friction-adjusting particles. The core layer is adjacent to the friction-generating layer and includes a core material. The core material includes core fibers. The base layer is adjacent to the core layer such that the core layer is disposed between the friction-generating and base layers. The base layer presents a bonding surface facing opposite the friction-generating surface of the friction-generating layer. The base layer includes a fibrous material. The fibrous material includes base fibers chosen from aramid fibers, carbon fibers, cellulose fibers, acrylic fibers, polyvinyl alcohol fibers, glass fibers, mineral fibers, and combinations thereof. A resin is present in at least one of the friction-generating layer, the core layer, and the base layer. The friction-generating material and the fibrous material are compositionally the same or different.

The base layer of the friction material presents the bonding surface. Advantageously, the-bonding surface generates friction and withstands repeated forces and elevated temperatures that are typically generated during the repeated engagement and disengagement of transmissions. The bonding surface also facilitates the formation of a robust bond to a substrate. As such, the friction material may be used in a wide variety of wet clutch applications and performs optimally across this wide variety of wet clutch applications.

### BRIEF DESCRIPTION OF THE FIGURES

Other advantages of the present disclosure will be readily appreciated, as the same becomes better understood by reference to the following detailed description when considered in connection with the accompanying drawings. The individual components in one or more of the drawings may not be shown to scale.

FIG. 1 is a cross-sectional view of one embodiment of a friction material including a friction-generating layer, a core layer, and a base layer including fibers.

FIG. 2 is a cross-sectional view of a friction plate including the friction material of claim 1.

FIG. 3 is a perspective view of a clutch assembly including a plurality of friction and separator plates in a transmission.

It should be appreciated that the drawings are illustrative in nature and are not necessarily drawn to scale.

### DETAILED DESCRIPTION OF THE DISCLOSURE

Referring to the Figures, wherein like numerals indicate corresponding parts throughout the several views, a friction material is shown generally at 10. The friction material 10 includes a friction-generating layer 12, a core layer 14, and a base layer 16. The friction-generating layer 12 presents a friction-generating surface 18, and the base layer 16 presents a bonding surface 20 facing opposite the friction-generating surface 18 of the friction-generating layer 12. The core layer 14 is adjacent to the friction-generating layer 12, and the base layer 16 is adjacent to the core layer 14 such that the core layer 14 is disposed between the friction-generating and base layers 12, 16. In some embodiments, the friction material 10 has a thickness T₁ defined as the distance between the friction-generating surface 18 and the bonding surface 20 and in many such embodiments, the friction-generating layer 12 extends from the friction-generating surface 18 towards the bonding surface 20 up to 10, 20, 30, or 40% of the thickness T₁, and the base layer 16 extends from the bonding surface 20 towards the friction-generating surface 18 up to 10, 20, 30, 40, 50, 60, or 70% of the thickness T₁.

It should be appreciated that include, includes, and including are the same as comprise, comprises, and comprising when used throughout this disclosure.

### The Friction Material:

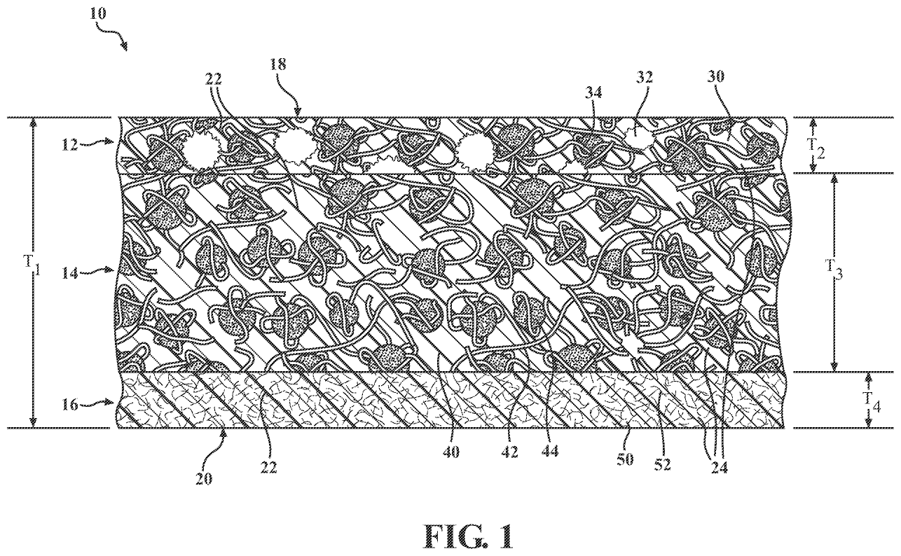

FIG. 1 is a cross-sectional view of two examples of the friction material 10 including the friction-generating layer 12, the core layer 14, and the base layer 16. The friction material 10 is porous with a resin 22 present in at least one of friction-generating layer 12, the core layer 14, and the base layer 16. Typically, the resin 22 is present in the friction-generating layer 12, the core layer 14, and the base layer 16. Each of the friction-generating layer 12, the core layer 14, the base layer 16, and the resin 22 is described in greater detail below.

### The Core Layer:

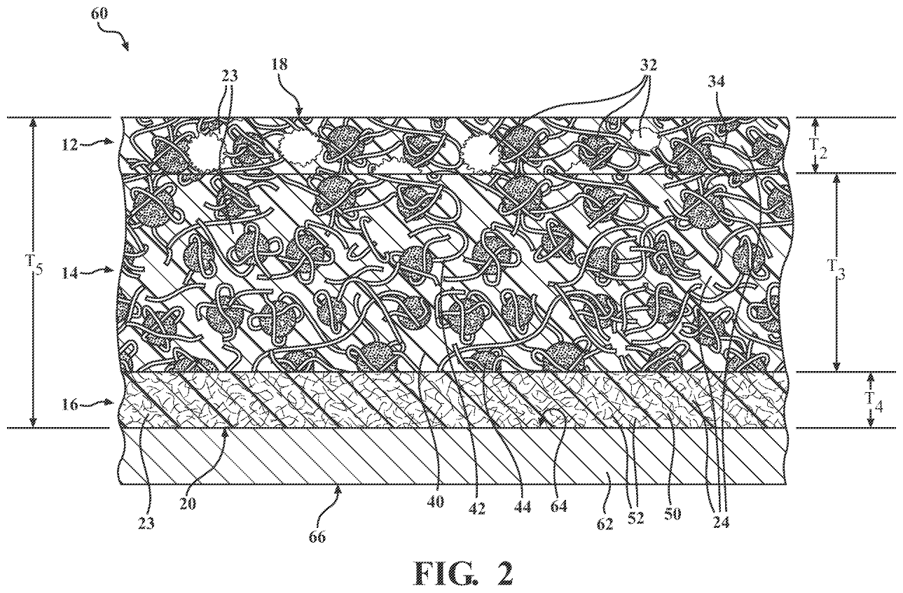

As shown in FIGS. 1 and 2, the friction material 10 includes the core layer 14. The core layer 14 may be alternatively described as a paper layer, a primary layer or as a porous layer. The core layer 14 may also be described as paper or raw paper. The core layer 14 may also be described as paper or raw paper. In some embodiments, the core layer 14 has a thickness T₃ of from 0.2 mm to 3.7 mm, from 0.3 mm to 3 mm, from 0.3 mm to 2.1 mm, from 0.3 mm to 2 mm, 0.4 mm to 1.9 mm, from 0.3 mm to 1 mm, from 0.3 mm to 0.9 mm, from 0.1 mm to 0.9 mm, from 0.4 mm to 0.8 mm, from 0.5 mm to 0.7 mm, from 0.6 mm to 0.7 mm, or from 0.2 mm to 0.35 mm. Alternatively, the thickness of the core layer 14 T₃ is less than 3.75 mm, less than 3 mm, less than 2 mm, less than 1 mm, less than 0.9 mm, less than 0.8 mm, less than 0.7 mm, less than 0.6 mm, less than 0.5 mm, or less than 0.4 mm, but greater than 0.1 mm. In additional non-limiting embodiments, all thickness T₃ values and ranges of values within and including the aforementioned range endpoints are hereby expressly contemplated. This thickness T₃ may refer to a thickness prior to, or after, resin 22 cure.

In some embodiments, the core layer 14 is discrete and well defined relative to edges and/or demarcation. In other embodiments, the core layer 14 is not discrete and well defined relative to edges and/or demarcation. In such embodiments, the core layer 14 is indiscrete and may blend or penetrate into the friction-generating layer 12 and/or the base layer 16 to varying degrees, as described in greater detail below. For example, the core layer 14 may blend into the friction-generating layer 12 and/or the base layer 16 in a gradient type of pattern.

The core layer 14 includes a core material 40. The core material 40 includes core fibers 42. The core fibers 42 may be alternatively described as a plurality of fibers. The core fibers 42 may include one or more different types of fibers. The core fibers 42 are typically present in an amount of from 20 to 100 weight percent or from 20 to 80 weight percent, based on a total weight of all non-resin components the core layer 14. In various embodiments, the core fibers 42 are present in an amount of from 25 to 75, 30 to 70, 35 to 65, 40 to 60, 45 to 55, or 45 to 50, weight percent based on a total weight of all non-resin components of the core layer 14. In additional non-limiting embodiments, all values and ranges of values of core fiber amounts within and including the aforementioned range endpoints are hereby expressly contemplated.

In some embodiments, the core material 40 consists essentially of core fibers 42 (and resin 22) or consists of core fibers 42 (and resin 22). To this end, the core material 40 can be substantially free of filler 44 or free of filler 44.

The core fibers 42 are not limited in type and may be chosen from aramid fibers, carbon fibers, cellulose fibers, acrylic fibers, polyvinyl alcohol fibers, glass fibers, mineral fibers, and combinations thereof. In various embodiments, the core fibers 42 are one or combinations of the aforementioned core fiber types. All weight ranges and ratios of the various combinations of the aforementioned core fiber types are hereby expressly contemplated in various non-limiting embodiments.

In various embodiments, the core fibers 42 include aramid. In other embodiments, the core fibers 42 consist of or consist essentially of aramid. Various non-limiting examples of aramids include tradenames such as KEVLAR®, TWARON®, NOMEX®, NEW STAR® and TEIJINCONEX®. One or more types of aramids may be used. In one embodiment, the aramid is poly-paraphenylene terephthalamide. In another embodiment, the aramid is two or more types of aramids, e.g. a first poly-paraphenylene terephthalamide and a second poly-paraphenylene terephthalamide that is different from the first. In various preferred embodiments, aramid fibers of the tradename TWARON® or KEVLAR® may be used. Of course, in other embodiments, aramid fibers of other tradenames may be used.

In some embodiments, the core fibers 42 include cellulose, e.g. from wood, cotton, etc. In other embodiments, the core fibers 42 consist essentially of or consist of cellulose. The cellulose fibers may be chosen from abacá fiber, bagasse fiber, bamboo fiber, coir fiber, cotton fiber, fique fiber, flax fiber, linen fiber, hemp fiber, jute fiber, kapok fiber, kenaf fiber, piña fiber, pine fiber, raffia fiber, ramie fiber, rattan fiber, sisal fiber, wood fiber, and combinations thereof. In some specific embodiments, cellulose fibers that are derived from wood are used, such as birch fibers and/or eucalyptus fibers. In other embodiments, cellulose fibers such as cotton fibers are used. If used, cotton fibers typically have fibrillated strands attached to a main fiber core and aid in preventing delamination of the friction material 10 during use.

In still other embodiments, the core fibers 42 include acrylic. Acrylic is formed from one or more synthetic acrylic polymers such as those formed from at least 85% by weight acrylonitrile monomers. In other embodiments, the core fibers 42 consist essentially of or consist of acrylic.

In various embodiments, the core fibers 42 have diameters from 1 μm to 500 μm and lengths from 0.1 mm to 20 mm. In additional non-limiting embodiments, all values and ranges of values of diameter within and including the aforementioned range endpoints are hereby expressly contemplated. The core fibers 42 may be woven, non-woven, or any other suitable construction.

In various embodiments, the core fibers 42 have a Canadian Standard Freeness (CSF) of greater than 40 or 50. In some embodiments, the core fibers 42 have a CSF of from 40 to 250 or from 40 to 125. In other embodiments, less fibrillated core fibers 42 are utilized which have a CSF of 250 to 750. In still other embodiments, the core fibers 42 have a CSF of 300 to 750 or greater than 750. In additional non-limiting embodiments, all values and ranges of values of CSF within and including the aforementioned range endpoints are hereby expressly contemplated.

The terminology “Canadian Standard Freeness” (T227 om-85) describes that the degree of fibrillation of fibers may be described as the measurement of freeness of the fibers. The CSF test is an empirical procedure which gives an arbitrary measure of the rate at which a suspension of three grams of fiber in one liter of water may be drained. Therefore, less fibrillated fibers have higher freeness or higher rate of drainage of fluid from the friction material 10 than other fibers or pulp. Notably, CSF values can be converted to Schopper Riegler values. The CSF can be an average value representing the CSF of all core fibers 42 in the core layer. As such, it is to be appreciated that the CSF of any one particular core fiber 42 may fall outside the ranges provided above, yet the average value will fall within these ranges.

In addition, the core material 40 may also include a filler 44. If included, the filler 44 can be present in an amount of up to 80 or from 20 to 80 weight percent based on a total weight of all non-resin components of the core material 40. In various embodiments, the filler 44 is present in an amount of from 25 to 75, 30 to 70, 35 to 65, 40 to 60, 45 to 55, or 45 to 50, weight percent based on a total weight of the core material 40. In additional non-limiting embodiments, all values and ranges of values of filler amounts within and including the aforementioned range endpoints are hereby expressly contemplated.

The filler 44 is not particularly limited and may be any known in the art. For example, the filler 44 may be a reinforcing filler or a non-reinforcing filler. The filler 44 may be chosen from silica, diatomaceous earth, graphite, carbon, alumina, magnesia, calcium oxide, titania, ceria, zirconia, cordierite, mullite, sillimanite, spodumene, petalite, zircon, silicon carbide, titanium carbide, boron carbide, hafnium carbide, silicon nitride, titanium nitride, titanium boride, and combinations thereof. In various embodiments, the filler 44 includes one or combinations of the aforementioned filler 44 types. All weight ranges and ratios of the various combinations of the aforementioned filler 44 types are hereby expressly contemplated in various non-limiting embodiments. In various embodiments, the filler 44 is diatomaceous earth.

The filler 44 may have a particle size from 0.5 μm to 250 μm, from 10 μm to 200 μm, 10 μm to 160 μm, 20 μm to 160 μm, or from 40 μm to 160 μm. In additional non-limiting embodiments, all values and ranges of values of particle size within and including the aforementioned range endpoints are hereby expressly contemplated.

In some embodiments, the core material 40 (or the core layer 14) comprises core fibers 42 selected from cellulose fibers, aramid fibers and carbon fibers and filler 44 selected from diatomaceous earth particles and carbon particles.

The core material 40 may further include additives known in the art.

### The Friction-Generating Layer:

As shown in FIGS. 1 and 2, the friction material 10 includes the friction-generating layer 12. The friction-generating layer 12 may also be referred to as a “deposit”. In some embodiments, the friction-generating layer 12 may be disposed on the core layer 14 and included in the friction material 10 as a distinct and well-defined layer or deposit. In other embodiments, the friction-generating layer 12 may be on the core layer 14 and disposed in the friction material 10 in a graduated pattern measured in a direction from the friction-generating surface 18 into the core layer 14 (towards the bonding surface 20) wherein a concentration of the components of the friction-generating layer 12 is greatest at the friction-generating surface 18.

In many embodiments, the friction-generating layer 12 has a thickness T₂ of from 10 μm to 600 μm, from 12 μm to 450 μm, from 12 μm to 300 μm, from 12 μm to 150 μm, or from 14 inn to 100 μm. Alternatively, the thickness T₂ of the friction-generating layer 12 is less than 150 inn, less than 150 μm, less than 125 μm, less than 100 μm, or less than 75 μm, but greater than 10 μm. In additional non-limiting embodiments, all values and ranges of values of thickness T₂ within and including the aforementioned range endpoints are hereby expressly contemplated. The thickness T₂ may refer to a thickness of the friction-generating layer 12 prior to, or after, resin 22 cure.

The friction-generating layer 12 includes a friction-generating material 30. The friction-generating material 30 includes friction-adjusting particles 32. The friction-adjusting particles 32 may include one or more different types of particles. The friction-adjusting particles 32 provide a high coefficient of friction to the friction material 10. The type or types of the friction-adjusting particles 32 utilized may vary depending on the friction characteristics sought.

In various embodiments, the friction-adjusting particles 32 are chosen from any of the one or more filler particle types (the filler 44) described above. Alternatively, the filler 44 above may be chosen from any one or more of the friction-adjusting particle types (friction-adjusting particles 32) described below.

The friction-generating material 30 may consist essentially of or consist of the friction-adjusting particles 32.

In various embodiments, the friction-adjusting particles 32 are chosen from silica particles, carbon particles, graphite particles, alumina particles, magnesia particles, calcium oxide particles, titania particles, ceria particles, zirconia particles, cordierite particles, mullite particles, sillimanite particles, spodumene particles, petalite particles, zircon particles, silicon carbide particles, titanium carbide particles, boron carbide particles, hafnium carbide particles, silicon nitride particles, titanium nitride particles, titanium boride particles, cashew nut particles, rubber particles, and combinations thereof.

In some embodiments, the friction-adjusting particles 32 are selected from carbon particles, diatomaceous earth particles, cashew nut particles, and combinations thereof.

In some embodiments, the friction-adjusting particles 32 include cashew nut particles. In yet other particular embodiments, the friction-adjusting particles 32 consist essentially of or consist of cashew nut particles or particles derived from cashew nut shell oil. Of course, in some such embodiments, the friction-generating material 30 consists essentially of or consists of cashew nut particles. Those of skill in the art understand cashew nut particles to be particles formed from cashew nut shell oil. Cashew nut shell oil is sometimes also referred to as cashew nut shell liquid (CNSL) and its derivatives.

In some embodiments, the friction-adjusting particles 32 include diatomaceous earth particles. Of course, in other embodiments, the friction-adjusting particles 32 consist essentially of or consist of diatomaceous earth particles. Of course, in some such embodiments, the friction-generating material 30 consists essentially of or consists of diatomaceous earth particles. Diatomaceous earth is a mineral comprising silica. Diatomaceous earth is an inexpensive, abrasive material that exhibits a relatively high coefficient of friction. CELITE® and CELATOM® are two trade names of diatomaceous earth that may be used.

In some embodiments, the friction-adjusting particles 32 include a combination of cashew nut particles and diatomaceous earth particles. Of course, in other embodiments, the friction-adjusting particles 32 consist essentially of or consist of a combination of cashew nut particles and diatomaceous earth particles. In some such embodiments, the friction-generating material 30 consists essentially of or consists of a combination of cashew nut particles and diatomaceous earth particles.

In various embodiments, the friction-adjusting particles 32 include elastomeric particles. Elastomeric particles exhibit elasticity and other rubber-like properties. Such elastomeric particles may be at least one particle type chosen from cashew nut particles and rubber particles. In some embodiments, rubber particles including silicone rubber, styrene butadiene rubber, butyl rubber, and halogenated rubbers such as chlorobutyl rubber, bromobutyl rubber, polychloroprene rubber, and nitrile rubber are used. In other embodiments, rubber particles consisting essentially of or consisting of silicone rubber, styrene butadiene rubber, butyl rubber, and halogenated rubbers such as chlorobutyl rubber, bromobutyl rubber, polychloroprene rubber, and nitrile rubber are used.

In some particular embodiments, the elastomeric particles include silicone rubber particles. In other particular embodiments, the elastomeric particles consist essentially of or consist of silicone rubber particles.

In some particular embodiments the elastomeric particles include nitrile rubber particles. In other particular embodiments, the elastomeric particles consist essentially of or consist of nitrile rubber particles.

In various embodiments, the friction-adjusting particles 32 have an average diameter of from 100 nm to 80 μm, from 500 nm to 30 μm, or from 800 nm to 20 μm. In additional non-limiting embodiments, all values and ranges of values of average diameter within and including the aforementioned range endpoints are hereby expressly contemplated.

The friction-generating material 30 may further include friction-adjusting fibers 34. The friction-adjusting fibers 34 may include different fiber types. In various embodiments, the friction-adjusting fibers 34 are chosen from any of the one or more of the core fiber types (core fibers 42) described above. Alternatively, the core fibers 42 may be chosen from any one or more of the friction-adjusting fibers 34 described below.

If included, the friction-adjusting fibers 34 are not particularly limited in type and may be chosen from aramid fibers, carbon fibers, cellulose fibers, acrylic fibers, polyvinyl alcohol fibers, glass fibers, mineral fibers, and combinations thereof. In various embodiments, the friction-adjusting fibers 34 are one or combinations of the aforementioned friction-adjusting fiber types. All weight ranges and ratios of the various combinations of the aforementioned friction-adjusting fiber types are hereby expressly contemplated in various non-limiting embodiments.

In some embodiments, the friction-generating material 30 includes friction-adjusting particles 32 but does not include the friction-adjusting fibers 34. Of course, in some such embodiments, the friction-generating material 30 consists essentially of or consists of friction-adjusting particles 32.

In other embodiments, the friction-generating material 30 includes both the friction-adjusting particles 32 and the friction-adjusting fibers 34. For example, in some particular embodiments, the friction-generating material 30 includes cellulose fibers, diatomaceous earth particles, and, optionally, elastomeric particles. In other particular embodiments, the friction-generating material 30 includes cellulose fibers, diatomaceous earth particles, and cashew nut particles.

The friction-generating material 30 may further include additives known in the art.

In various embodiments, the components (e.g. the friction-adjusting particles 32, friction-adjusting fibers 34, and/or any additives) of the friction-generating layer 12 or friction-generating deposit are utilized in an amount of from 0.5 to 100 lbs. per 3000 ft² (0.2 to 45.4 kg per 278.71 m²) of a surface of the core layer 14, from 3 to 80 lbs. per 3000 f^{t2} (1.4 kg to 36.3 kg per 278.71 m²) of the surface of the core layer 14, from 3 to 60 lbs. per 3000 f^{t2} (1.4 kg to 27.2 kg per 278.71 m²) of the surface of the core layer 14, from 3 to 40 lbs. per 3000 f^{t2} (1.4 kg to 18.1 kg per 278.71 m²) of the surface of the core layer 14, from 3 to 20 lbs. per 3000 f^{t2} (1.4 kg to 9.1 kg per 278.71 m²) of the surface of the core layer 14, from 3 to 12 lbs. per 3000 f^{t2} (1.4 kg to 5.4 kg per 278.71 m²) of the surface of the core layer 14, or from 3 to 9 lbs. per 3000 f^{t2} (1.4 kg to 4.1 kg per 278.71 m²) of the surface of the core layer 14. In additional non-limiting embodiments, all values and ranges of values of amounts within and including the aforementioned range endpoints are hereby expressly contemplated. The amounts described immediately above are in units of lbs. per 3000 ft², which are units customarily used in the paper making industry as a measurement of weight based on a surface area. Above, the units express the weight of the friction-generating material 30 for every 3000 ft² of the surface of the core layer 14.

### The Base Layer:

As shown in FIGS. 1 and 2, the friction material 10 includes the base layer 16. The base layer 16 provides the friction material 10 with robust adhesion to various substrates. That is, the base layer 16 has the bonding surface 20 which possesses multi-functionality, functions to promote adhesion to a substrate 62. Plus, the base fibers 52 of the base layer allow for quick and efficient dissipation of heat. Accordingly, this multi-functional base layer 16 allows for the use of the friction material 10 in a wide array of wet clutch applications.

The base layer 16 may also be referred to as a “deposit”. In some embodiments, the base layer 16 may be disposed on the core layer 14 and included in the friction material 10 as a distinct and well-defined layer or deposit. In other embodiments, the base layer 16 may be disposed on the core layer 14 and included in the friction material 10 in a graduated pattern measured in a direction from the bonding surface 20 into the core layer 14 (towards the friction-generating surface 18) wherein a concentration of the components of the base layer 16 is greatest at the bonding surface 20.

In many embodiments, the base layer 16 has a thickness T₄ of from 10 μm to 1,500 μm, 10 μm to 1,000 μm, from 10 μm to 650 μm, from 12 μm to 450 μm, from 12 μm to 300 μm, from 12 μm to 150 μm, or from 14 μm to 100 μm. Alternatively, the thickness T₄ of the base layer 16 is less than 150 μm, less than 150 μm, less than 125 μm, less than 100 μm, or less than 75 μm, but greater than 10 μm. In additional non-limiting embodiments, all values and ranges of values of thickness T₄ within and including the aforementioned range endpoints are hereby expressly contemplated. This thickness T₄ may refer to a thickness prior to, or after, resin 22 cure.

The base layer 16 includes a fibrous material 50. The fibrous material 50 includes base fibers 52 chosen from aramid fibers, carbon fibers, cellulose fibers, acrylic fibers, polyvinyl alcohol fibers, glass fibers, mineral fibers, and combinations thereof; and/or base particles. That is, the base layer 16 is chosen from embodiments wherein the fibrous material 50 includes the base fibers 52, embodiments wherein the fibrous material 50 includes the base particles, or embodiments wherein the fibrous material 50 includes both the base fibers 52 and the base particles.

In many embodiments the base layer 16 comprises the fibrous material 50 including base fibers 52 which are non-woven. In some such embodiments the base fibers 52 that are non-woven are opened and entangled to form a single cohesive body which can be referred to as a paper, a sheet, a substrate, or a web. In alternative embodiments, the base layer 16 comprises a fibrous material including base fibers 52 that are woven. The base fibers 52 are referred to as woven because the base fibers 52 include at least some regular entanglement. That is, the base fibers 52 are referred to as woven because they are more than randomly entangled. In many such embodiments, the base fibers 52 are referred to as woven because the base fibers 52 are opened, made into strands, and the strands are woven or knitted into fabric to form an organized entanglement of base fibers which form a single cohesive body. In some embodiments, the base layer 16 is substantially free of or free of base fibers 52 that are woven.

The base fibers 52 included in the fibrous material 50 of the base layer 16 are chosen from at least one of aramid fibers, carbon fibers, cellulose fibers, acrylic fibers, polyvinyl alcohol fibers, glass fibers, and mineral fibers. In some embodiments, the fibrous material 50 consists essentially of or consists of base fibers 52. In some embodiments, the base layer 16 consists essentially of or consists of base fibers 52.

The base fibers 52 of the fibrous material 50 may be chosen from any of the core fiber types (core fibers 42) described above.

In many embodiments, the fibrous material 50 includes cellulose fibers. In such embodiments, the base fibers 52 may include fibers chosen from abacá fiber, bagasse fiber, bamboo fiber, coir fiber, cotton fiber, fique fiber, flax fiber, linen fiber, hemp fiber, jute fiber, kapok fiber, kenaf fiber, piña fiber, pine fiber, raffia fiber, ramie fiber, rattan fiber, sisal fiber, wood fiber, and combinations thereof. In some particular embodiments, the base fibers 52 include cellulose fibers, and the cellulose fibers include cotton fiber. In some particular embodiments, the base fibers 52 consist essentially of cotton base fiber or consist of cotton base fiber. Of course, in some such embodiments, the fibrous material 50 consists essentially of or consists of cellulose or cotton base fibers.

Cellulose base fibers 52 provide improved bonding to the substrate 62 and delamination resistance (i.e. a reduction in cohesive and adhesive failure). The bonding surface 20 of the base layer 16 promotes adhesion to the substrate 62 and forms a robust bond.

In yet other particular embodiments, the base fibers 52 include carbon fiber. In other embodiments, the base fibers 52 consist essentially of or consist of carbon fiber. Carbon fibers can provide increased thermal resistance to the friction material, improved bonding to the substrate 62, delamination resistance, and squeal or noise resistance.

In still other particular embodiments, the base fibers 52 include aramid fiber. In other embodiments, the base fibers 52 consist essentially of or consist of aramid fiber.

In various embodiments, the base fibers 52 have average diameters of from 2 to 80, from 2 to 60, μm, and average lengths of from 0.5 to 15, from 0.5 to 9, from 1 to 9, from 1 to 8, from 1 to 7, from 1 to 6, from 1 to 5, from 1 to 4 from 1 to 3, from 2 to 15, from 2 to 9, from 2 to 6, from 3 to 5, or from 2 to 3, mm. In additional non-limiting embodiments, all values and ranges of values diameter within and including the aforementioned range endpoints are hereby expressly contemplated.

In many embodiments, the base fibers 52 have a degree of fibrillation as measured according to Canadian Standard Freeness (“CSF”) of from 5 to 800. CSF is initially described above in relation to the core fibers 42. In such embodiments, the base fibers 52 may have a more specific degree of fibrillation as measured according to CSF of from 100 to 800, from 200 to 800, from 300 to 800, from 200 to 700, from 200 to 600, from 10 to 200, from 10 to 100, from 10 to 640, from 10 to 500, from 100 to 640, or from 100 to 500, ml CSF. In additional non-limiting embodiments, all values and ranges of degree of fibrillation values within and including the aforementioned range endpoints are hereby expressly contemplated.

In some embodiments, the base fibers 52 are present in said friction material 10 an amount of from 1 to 90, from 1 to 75, from 5 to 75, from 10 to 75, or from 15 to 75, weight percent based on the total weight percent based on a total weight of all non-resin components in the friction material 10. In additional non-limiting embodiments, all values and ranges of amount values within and including the aforementioned range endpoints are hereby expressly contemplated. The amount of the base fibers 52 present in the friction material 10 may vary outside of the ranges above, but is typically both whole and fractional values within these ranges. Further, it is to be appreciated that more than one type of the base fibers 52 may be included in the friction material 10, in which case the total amount of all the base fibers 52 present in the friction material 10 is within the above ranges.

In various embodiments, the components (e.g. the base fibers 52, the friction-adjusting particles 32, and/or the additives) of the base layer 16 or base deposit are utilized in an amount of from 0.5 to 500 lbs. per 3000 ft² (0.2 to 226.8 kg per 278.71 m²) of a second surface of the core layer 14, 0.5 to 100 lbs. per 3000 ft² (0.2 to 45.4 kg per 278.71 m²) of a second surface of the core layer 14, from 3 to 80 lbs. per 3000 f^{t2} (1.4 kg to 36.3 kg per 278.71 m²) of the second surface of the core layer 14, from 3 to 60 lbs. per 3000 f^{t2} (1.4 kg to 27.2 kg per 278.71 m²) of the second surface of the core layer 14, from 3 to 40 lbs. per 3000 f^{t2} (1.4 kg to 18.1 kg per 278.71 m²) of the second surface of the core layer 14, from 3 to 20 lbs. per 3000 f^{t2} (1.4 kg to 9.1 kg per 278.71 m²) of the second surface of the core layer 14, from 3 to 12 lbs. per 3000 f^{t2} (1.4 kg to 5.4 kg per 278.71 m²) of the second surface of the core layer 14, or from 3 to 9 lbs. per 3000 f^{t2} (1.4 kg to 4.1 kg per 278.71 m²) of the second surface of the core layer 14. In additional non-limiting embodiments, all values and ranges of values of amounts within and including the aforementioned range endpoints are hereby expressly contemplated. The amounts described immediately above are in units of lbs. per 3000 ft², which are units customarily used in the paper making industry as a measurement of weight based on a surface area. Above, the units express the weight of the friction-generating material 30 for every 3000 ft² of the second surface of the core layer 14.

As suggested above, in some embodiments, the fibrous material 50 consists essentially of or consists of the base fibers 52. In other embodiments, the fibrous material 50 includes a combination of components.

In some embodiments, the fibrous material 50 of the base layer 16 further includes particles such as the friction-adjusting particles 32 described above. In such embodiments, the fibrous material 50 may include one or more of the types of friction-adjusting particles (the friction-adjusting particles 32) described above.

The fibrous material 50 may further include additives known in the art.

In most embodiments, the friction-generating material 30 of the friction-generating layer 12, the core material 40 of the core layer 14, and the fibrous material 50 of the base layer 16 are compositionally different. FIG. 1 is a cross-sectional view of an embodiment of the friction material 10 including the friction-generating layer 12, the core layer 14, and the base layer 16 which are compositionally different.

In one example, the friction material 10 includes: the friction-generating layer 12 comprising the friction-generating material 30, the friction-generating material 30 comprising the friction-adjusting particles 32 comprising diatomaceous earth particles and/or cashew nut particles; the core layer 14 comprising the core material 40, the core material 40 comprising (1) the core fibers 42 comprising aramid fibers and cellulose fibers and (2) the filler 44 comprising diatomaceous earth and carbon particles; and the base layer 16 comprising the fibrous material 50, the fibrous material 50 comprising the base fibers 52 comprising cellulose wherein the cellulose fibers having a length of from 1 to 9 mm.

It should be appreciated that the terminology “consists essentially of” as used throughout this disclosure describes embodiments that include a designated component (e.g. cellulose fibers) or components of a particular component class (e.g. base fibers 52) and less than 5, 4, 3, 2, 1, 0.5, 0.1, 0.05, or 0.01 percent by weight of all other like components (e.g. additional aramid fibers) of the particular component class, based on the total weight of the particular component class included in the friction material 10.

As a non-limiting example, the term “base fibers 52 that consist essentially of cotton fiber”, as described above, describes base fibers 52 that include cotton fiber and less than 5, 4, 3, 2, 1, 0.5, 0.1, 0.05, or 0.01 percent by weight other base fibers 52, based on a total weight of the base fibers 52 included in the fibrous material 50 (or a total weight of the base layer 16 as an alternative basis) of friction material 10.

It should also be appreciated that the terminology “consists essentially of” as used throughout this disclosure describes embodiments that include a designated component (e.g. cellulose fibers) or components in a particular material (e.g. the fibrous material 50) and less than 5, 4, 3, 2, 1, 0.5, 0.1, 0.05, or 0.01, percent by weight of other components (e.g. additional fibers, particles, additives, etc.) in the particular material, based on a total weight of all components in the material 30, 40, or 50 (excluding the resin 22).

As a non-limiting example, the “fibrous material 50 that consist essentially of cotton fiber”, as described above, describes the fibrous material 50 that includes cotton fiber and less than 5, 4, 3, 2, 1, 0.5, 0.1, 0.05, or 0.01 percent by weight of all other components included in the fibrous material 50, based on a total weight of all components in fibrous material 50 (excluding resin 22).

As a further non-limiting example, the “base layer 16 that consists essentially of cotton fiber”, as described above, describes the base layer 16 that includes cotton fiber and less than 5, 4, 3, 2, 1, 0.5, 0.1, 0.05, or 0.01 percent by weight of all other components included in the base layer 16, based on a total weight of all components in the base layer 16 (excluding resin 22).

### The Resin:

As shown in FIGS. 1 and 2, the resin 22 is present in the friction material 10. The resin 22 may be dispersed homogeneously or heterogeneously within the friction material 10. For example, the resin 22 may be dispersed in at least one of the core layer 14, the friction-generating layer 12, and the base layer 16. As yet another example, at least one of the core layer 14, the friction-generating layer 12, and the base layer 16 may include one or more different types of the resin 22. In various embodiments, the resin 22 is dispersed homogeneously or heterogeneously throughout the core layer 14 and may partially or wholly encapsulate one or more of the friction-generating layer 12 and the base layer 16. In the Figures, the numeral 22 refers to uncured resin whereas the numeral 23 refers to cured resin.

The resin 22 may be any known in the art and may be curable. Alternatively, the resin 22 may be of the type that does not cure. In various embodiments, depending on the stage of formation of the friction material 10, the resin 22, 23 may be uncured, partially cured, or entirely cured.

In some embodiments, the resin 22 may be any thermosetting resin suitable for providing structural strength to the friction material 10. Various resins 22 that may be utilized include phenolic resins and phenolic-based resins. A phenolic resin is a class of thermosetting resins that is produced by the condensation of an aromatic alcohol, typically a phenol, and an aldehyde, typically a formaldehyde. A phenolic-based resin is a thermosetting resin blend that typically includes at least 50 wt. % of a phenolic resin based on the total weight of all resins and excluding any solvents or processing acids. It is to be understood that various phenolic-based resins may include modifying ingredients, such as epoxy, butadiene, silicone, tung oil, benzene, cashew nut oil and the like. In some embodiments, a silicone modified phenolic resin which includes 5 to 80 weight percent of a silicone resin with the remainder weigh percent being attributed to a phenolic resin or combination of phenolic and other different resins is used. In other embodiments, an epoxy modified phenolic resin which includes 5 to 80 weight percent weigh percent of an epoxy resin with the remainder weigh percent being attributed to a phenolic resin or combination of phenolic and other different resins is used.

In one or more embodiments, the resin 22 may include, for example, 5 to 100 or 5 to 80, weight percent of a silicone resin based on the total weight of all resins and excluding any solvents or processing acids. Silicone resins that may be used may include thermal curing silicone sealants and silicone rubbers. Various silicone resins may also be used such as those that include D, T, M, and Q units (e.g. DT resins, MQ resins, MDT resins, MTQ resins, QDT resins . . . ).

In various embodiments, the resin 22 is present in an amount of from 20 to 90, 20 to 80, or 25 to 60, weight percent based on a total weight of all non-resin components in the friction material 10. For example, the resin 22 may be present in an amount of from 25 to 75, 25 to 70, 30 to 75, 30 to 70, or 30 to 55, or 35 to 65, weight percent based on a total weight of all non-resin components in the friction material 10. This value may be alternatively described as resin “pick up.” In additional non-limiting embodiments, all values and ranges of values of resin amounts within and including the aforementioned range endpoints are hereby expressly contemplated.

Once cured, the cured resin 23 confers strength and rigidity to the friction material 10 and adheres the components of the layers 12, 14, 16 to one another while maintaining a desired porosity for proper lubricant flow and retention, and also bonds the friction material 10 to the substrate 62, as described below.

### The Physical Properties of the Friction Material:

As shown in Figures land 2, the friction material 10 includes a plurality of pores 24. Each of the pores 24 has a pore size.

The pores 24 may be dispersed homogeneously or heterogeneously throughout the friction material 10. For example, at least one of the core layer 14, the friction-generating layer 12, and the base layer 16 may include the pores 24 (be porous). In some examples, at least one of the core layer 14, the friction-generating layer 12, and the base layer 16 have a different porosity, average pore size, and/or median pore size. In other examples, the core layer 14, the friction-generating layer 12, and the base layer 16 have about the same porosity average pore size, and/or mean pore size.

The median pore size may be determined using American Society for Testing and Materials (“ASTM”) test method D4404-10. In various embodiments, the median pore size in the friction material 10 is, from 0.5 to 50, 1 to 50, 2 to 50, 2 to 45, 2 to 30, 2 to 15, or 3 to 10, μm as determined using ASTM test method D4404-10. In additional non-limiting embodiments, all values and ranges of values of median pore size within and including the aforementioned range endpoints are hereby expressly contemplated.

In other embodiments, the friction material 10 has a porosity of from 5% to 90% or 25% to 85% as determined using ASTM test method D4404-10. The porosity of the friction material 10 may be described as a percentage of the friction material 10 that is open to air. Alternatively, the porosity may be described as the percentage of the friction material 10, based on volume, that is air or not solid. In various embodiments, the friction material 10 has a porosity of from 30 to 80, or 40 to 75, % as determined using ASTM test method D4404-10. In additional non-limiting embodiments, all values and ranges of values of porosity within and including the aforementioned range endpoints are hereby expressly contemplated. In some embodiments, the friction-generating layer 12 has a lower porosity than the core layer 14 and/or the base layer 16 (as determined using ASTM test method D4404-10. In some embodiments, the base layer 16 has a lower porosity than the core layer 14 as determined using ASTM test method D4404-10. In some embodiments, the base layer 16 has a greater porosity than the core layer 14 as determined using ASTM test method D4404-10.

The more porous the friction material 10, the more efficiently heat is dissipated. The oil flow in and out of the friction material 10 during engagement of the friction material 10 during use occurs more rapidly when the friction material 10 is porous. For example, when the friction material 10 has a higher mean flow pore diameter and porosity, the friction material 10 is more likely to run cooler or with less heat generated in a transmission due to better automatic transmission fluid flow throughout the pores 24 of the friction material 10. During operation of a transmission, oil deposits on the friction material 10 tend to develop over time due to a breakdown of automatic transmission fluid, especially at high temperatures. The oil deposits tend to decrease the size of the pores 24. Therefore, when the friction material 10 is formed with larger pores 24, the greater the remaining/resultant pore size after oil deposit. Porosity of the friction material 10 may be further modified based on choice of the fibers (34, 42, 52), the resin 22, the friction-adjusting particles 32, the filler 44, the base particles, the composition of the layers (12, 14, 16), and a raw paper weight.

In various embodiments, the friction material 10 has high porosity such that there is a high fluid permeation capacity during use. In such embodiments, it may be important that the friction material 10 not only be porous, but also be compressible. For example, the fluids permeated into the friction material 10 typically must be capable of being squeezed or released from the friction material 10 quickly under the pressures applied during operation of the transmission, yet the friction material 10 typically must not collapse. It may also be important that the friction material 10 have high thermal conductivity to also help rapidly dissipate the heat generated during operation of the transmission.

The initial thickness T₁ of the friction material 10, is typically from 0.3 to 4, from 0.4 to 3, from 0.4 to 2, from 0.4 to 1.6, from 0.4 to 1.5, from 0.5 to 1.4, from 0.6 to 1.3, from 0.7 to 1.2, from 0.8 to 1.1, or from 0.9 to 1, mm. This thickness T₁ refers to a thickness prior to bonding to the substrate 62 and may be referred to as caliper thickness. This thickness T₁ can refer to the thickness of the friction material with uncured resin present, or the thickness of the raw paper without resin 22. In additional non-limiting embodiments, all values and ranges of values of thickness T₁ within and including the aforementioned range endpoints are hereby expressly contemplated.

After bonding to the substrate 62 and resin 23 cure, a total thickness T₅ of the friction material 10 is typically from 0.3 to 3.75, from 0.4 to 3, from 0.4 to 2, from 0.4 to 1.6, from 0.4 to 1.5, from 0.5 to 1.4, from 0.6 to 1.3, from 0.7 to 1.2, from 0.8 to 1.1, or from 0.9 to 1, mm. This thickness T₅ is typically measured after bonding to the substrate 62. In additional non-limiting embodiments, all values and ranges of values of total thickness T₅ within and including the aforementioned range endpoints are hereby expressly contemplated.

In still other embodiments, the friction material 10 has a compression of from 2 to 30, from 4 to 15, or from 6 to 8, percent, at 2 MPa. Compression is a material property of the friction material 10 that may be measured when the friction material 10 is disposed on the substrate 62 (i.e., measured when part of a friction plate 60, described below) or when the friction material 10 is not disposed on the substrate 62. Typically, compression is a measurement of a distance (e.g. mm) that the friction material 10 is compressed under a certain load. For example, a thickness of the friction material 10 before a load is applied is measured. Then, the load is applied to the friction material 10. After the load is applied for a designated period of time, the new thickness of the friction material 10 is measured. Notably, this new thickness of the friction material 10 is measured as the friction material 10 is still under the load. The compression is typically related to elasticity, as would be understood by those of skill in the art. The more elastic the friction material 10 is, the more return that will be observed after compression. This typically leads to less lining loss and formation of less hot spots, both of which are desirable. In additional non-limiting embodiments, all values and ranges of compression values within and including the aforementioned range endpoints are hereby expressly contemplated.

In various embodiments, the friction material 10 is bonded to the substrate 62, which is typically metal. Several examples of the substrate 62 include, but are not limited to, a clutch plate, a synchronizer ring, and a transmission band. The friction material 10 includes the friction-generating surface 18 and an oppositely facing bonding surface 20. The friction-generating surface 18 experiences select interfacial frictional engagement with the opposed, rotating surface in the presence of a lubricant. The bonding surface 20 possess multi-functionality, functioning to (1) promote adhesion to the substrate 62, and (2) reduce the build-up of heat when the friction material is in use.

When bonded to the substrate 62, the bonding surface 20 achieves bonded attachment to the substrate 62 with or without the aid of an adhesive or some other suitable bonding technique. In one exemplary embodiment, which is described below, the friction material 10 is used in the friction plate 60 with the bonding surface 20 promoting a robust bond between the friction material 10 and the substrate 62.

The lubricant may be any suitable lubricating fluid such as an automatic transmission fluid. The flow rate of the lubricant over the friction material 10 may be managed to allow the temperature at the friction-generating surface 18 and or the bonding surface 20 to exceed 350° C. for extended periods in an effort to improve fuel efficiency. In various embodiments, while the friction material 10 performs satisfactorily above 350° C., and up to 500° C., it is not limited only to such high-temperature environments and may, if desired, be used in a wet clutch designed to maintain a temperature at the friction-generating surface 18 below 350° C. In additional non-limiting embodiments, all values and ranges of values of operating temperatures within and including the aforementioned range endpoints are hereby expressly contemplated.

### Friction Plate:

As shown in FIG. 2, this disclosure also provides the friction plate 60 that includes the friction material 10 and the substrate 62 (e.g. a metal plate), as first introduced above. The substrate 62 has at least two surfaces 64, 66, and the friction material 10 is typically bonded to one or both of these surfaces 64, 66. The bonding or adherence of the friction material 10 to one or both surfaces 64, 66 may be achieved by any adhesive or means known in the art, e.g. a phenolic resin or any resin 22, 23 described above.

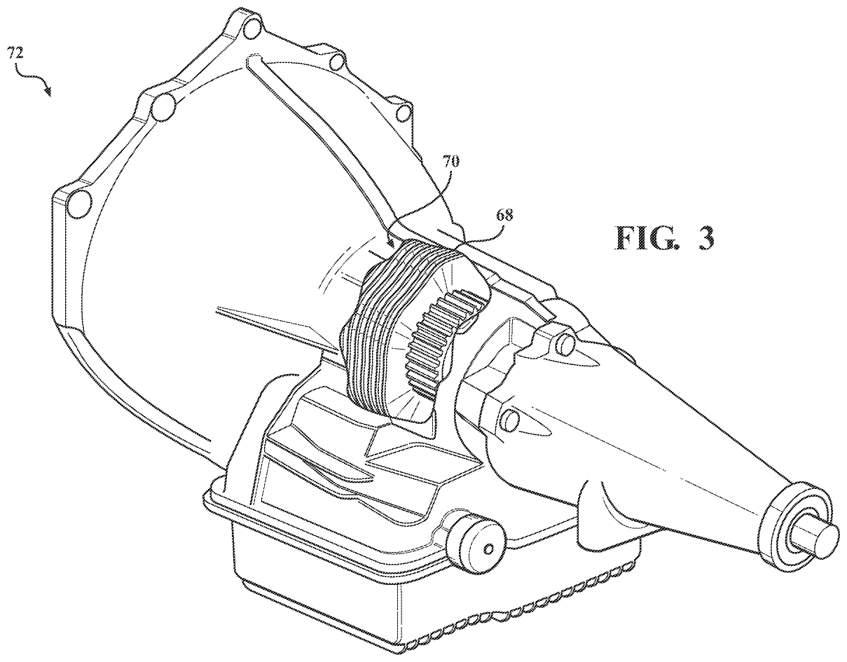

Referring now to FIG. 3, the friction plate 60 may be used, sold, or provided with a separator plate 68 to form a clutch pack or clutch assembly 70. The clutch assembly may be a “wet” clutch assembly or a “wet” clutch, which functions in the presence of fluid. This disclosure also provides the friction plate 60 itself including the friction material 10 and the substrate 62 and a clutch assembly 70 including the friction plate 60 and the separator plate 68.

Still referring to FIG. 3, this disclosure also provides a transmission 72 that includes the clutch assembly 70. The transmission 72 may be an automatic transmission or a manual transmission.

All combinations of the aforementioned embodiments throughout the entire disclosure are hereby expressly contemplated in one or more non-limiting embodiments even if such a disclosure is not described verbatim in a single paragraph or section above. In other words, an expressly contemplated embodiment may include any one or more elements described above selected and combined from any portion of the disclosure.

One or more of the values described above may vary by ±5%, ±10%, ±15%, ±20%, ±25%, etc. so long as the variance remains within the scope of the disclosure. Unexpected results may be obtained from each member of a Markush group independent from all other members. Each member may be relied upon individually and or in combination and provides adequate support for specific embodiments within the scope of the appended claims. The subject matter of all combinations of independent and dependent claims, both singly and multiply dependent, is herein expressly contemplated. The disclosure is illustrative including words of description rather than of limitation. Many modifications and variations of the present disclosure are possible in light of the above teachings, and the disclosure may be practiced otherwise than as specifically described herein.

It is also to be understood that any ranges and subranges relied upon in describing various embodiments of the present disclosure independently and collectively fall within the scope of the appended claims and are understood to describe and contemplate all ranges including whole and/or fractional values therein, even if such values are not expressly written herein. One of skill in the art readily recognizes that the enumerated ranges and subranges sufficiently describe and enable various embodiments of the present disclosure, and such ranges and subranges may be further delineated into relevant halves, thirds, quarters, fifths, and so on. As just one example, a range “of from 0.1 to 0.9” may be further delineated into a lower third, i.e. from 0.1 to 0.3, a middle third, i.e. from 0.4 to 0.6, and an upper third, i.e. from 0.7 to 0.9, which individually and collectively are within the scope of the appended claims, and may be relied upon individually and/or collectively and provide adequate support for specific embodiments within the scope of the appended claims. In addition, with respect to the language which defines or modifies a range, such as “at least,” “greater than,” “less than,” “no more than,” and the like, it is to be understood that such language includes subranges and/or an upper or lower limit. As another example, a range of “at least 10” inherently includes a subrange of from at least 10 to 35, a subrange of from at least 10 to 25, a subrange of from 25 to 35, and so on, and each subrange may be relied upon individually and/or collectively and provides adequate support for specific embodiments within the scope of the appended claims. Finally, an individual number within a disclosed range may be relied upon and provides adequate support for specific embodiments within the scope of the appended claims. For example, a range “of from 1 to 9” includes various individual integers, such as 3, as well as individual numbers including a decimal point (or fraction), such as 4.1, which may be relied upon and provide adequate support for specific embodiments within the scope of the appended claims.

What is claimed is:

1. A friction material comprising:
a friction-generating layer presenting a friction-generating surface and comprising a friction-generating material, said friction-generating material comprising friction-adjusting particles;
a core layer adjacent to said friction-generating layer, said core layer comprising a core material, said core material comprising core fibers; and
a base layer adjacent to said core layer such that said core layer is disposed between said friction-generating and base layers, said base layer presenting a bonding surface facing opposite said friction-generating surface of said friction-generating layer, said base layer comprising a fibrous material, said fibrous material comprising base fibers chosen from aramid fibers, carbon fibers, cellulose fibers, acrylic fibers, polyvinyl alcohol fibers, glass fibers, mineral fibers, and combinations thereof, said base fibers having a length of from 0.5 to 15 mm;
wherein a resin is present in at least one of said friction-generating layer, said core layer, and said base layer.

2. The friction material as set forth in claim 1 wherein said base fibers comprise cellulose fibers chosen from abacá fiber, bagasse fiber, bamboo fiber, coir fiber, cotton fiber, fique fiber, flax fiber, linen fiber, hemp fiber, jute fiber, kapok fiber, kenaf fiber, piña fiber, pine fiber, raffia fiber, ramie fiber, rattan fiber, sisal fiber, wood fiber, and combinations thereof.

3. The friction material as set forth in claim 1 wherein said base fibers comprise cotton fiber.

4. The friction material as set forth in claim 1 wherein said base fibers have a diameter of from 2 to 80 μm and/or a length of from 1 to 9 mm.

5. The friction material as set forth in claim 1 wherein said base fibers have a Canadian Standard Freeness (CSF) degree of fibrillation of from 200 to 800.

6. The friction material as set forth in claim 1 wherein:
said friction-generating layer has a thickness of from 10 to 600 μm;
said core layer has a thickness from 0.2 mm to 3.75 mm; and/or
said base layer has a thickness of from 10 μm to 1,500 μm.

7. The friction material as set forth in claim 1 wherein said fibrous material consists essentially of base fibers.

8. The friction material as set forth in claim 1 wherein said base layer has a greater porosity than said core layer as determined using ASTM test method D4404-10.

9. The friction material as set forth in claim 1 wherein said friction-adjusting particles are selected from carbon particles, diatomaceous earth particles, cashew nut particles, and combinations thereof.

10. The friction material as set forth in claim 1 wherein said friction-adjusting particles have an average diameter of from 100 nm to 80 μm.

11. The friction material of claim 1 wherein said friction-adjusting particles are present in said friction-generating material in an amount of from 0.5 to 100 lbs. based on 3000 ft² of said friction material.

12. The friction material as set forth in claim 1 wherein said friction-generating material further comprises cellulose fibers.

13. The friction material as set forth in claim 1 wherein said friction-generating layer has a lower porosity than said core layer and/or said base layer as determined using ASTM test method D4404-10.

14. The friction material as set forth in claim 1 having a thickness defined as a distance between said friction-generating surface and said bonding surface, wherein said friction-generating layer extends from said friction-generating surface towards said bonding surface up to 40% of said thickness, and said base layer extends from said bonding surface towards said friction-generating surface up to 70% of said thickness.

15. The friction material as set forth in claim 1 wherein said resin is present in said friction-generating layer, said core layer, and said base layer.

16. The friction material as set forth in claim 15 wherein said resin is present in an amount of from 20 to 90 weight percent based on a total weight of all non-resin components in said friction material.

17. A friction plate comprising a substrate and said friction material as set forth in claim 1, which is cured and bonded to said substrate.

18. A wet clutch assembly comprising said friction plate of claim 17 and a separator plate.

19. A transmission comprising said wet clutch assembly of claim 18.

20. A friction material comprising:
a friction-generating layer presenting a friction-generating surface and comprising a friction-generating material, said friction-generating material comprising:
friction-adjusting particles comprising diatomaceous earth particles and/or cashew nut particles;
a core layer adjacent to said friction-generating layer, said core layer comprising a core material, said core material comprising:
core fibers comprising aramid fibers and cellulose fibers; and
filler comprising carbon particles and diatomaceous earth particles;
a base layer adjacent to said core layer such that said core layer is disposed between said friction-generating and base layers, said base layer presenting a bonding surface facing opposite said friction-generating surface of said friction-generating layer, said base layer comprising a fibrous material, said fibrous material comprising:
base fibers comprising cotton and having a length of from 0.5 to 9 mm;
wherein a resin is present in said friction-generating layer, said core layer, and said base layer.
